(19) United States
(12) Patent Application Publication
(10) Pub. No.: US 2012/0173289 A1
(43) Pub. Date: Jul. 5, 2012

(54) SYSTEM AND METHOD FOR DETECTING AND IDENTIFYING PATTERNS IN INSURANCE CLAIMS

(75) Inventors: Michael E. Pollard, Rockville, MD (US); Kevin J. McCurry, Winchester, MA (US); Matthew A. Probus, Fairfax, VA (US); Kirk G. Barben, Gaithersburg, MD (US)

(73) Assignee: THOMSON REUTERS (SIENTIFIC) LLC, Philadelphia, PA (US)

(21) Appl. No.: 13/234,361

(22) Filed: Sep. 16, 2011

Related U.S. Application Data
(60) Provisional application No. 61/383,654, filed on Sep. 16, 2010.

(51) Int. Cl. G06Q 40/08; G06F 7/00

(52) U.S. Cl. 705/4; 707/812; 707/E17.044

(57) ABSTRACT

The invention relates generally to a system and method for detecting patterns of behavior in reported insurance claims. More particularly, the invention resolves insurance claim data with other demographic, activity and other related data about individuals and entities to detect specific subsets of entities and individuals and their insurance claims behaviors.

### RELATED APPLICATIONS

This application claims priority to U.S. Provisional Application Ser. No. 61/383,654, filed Sep. 16, 2010, entitled SYSTEM AND METHOD FOR DETECTING AND IDENTIFYING PATTERNS IN INSURANCE CLAIMS, the contents of which are incorporated herein by reference.

### COPYRIGHT NOTICE AND PERMISSION

A portion of this patent document contains material subject to copyright protection. The copyright owner has no objection to the facsimile reproduction by anyone of the patent document or the patent disclosure, as it appears in the Patent and Trademark Office patent files or records, but otherwise reserves all copyrights whatsoever. The following notice applies to this document: Copyright© 2010 Thomson Reuters Global Resources

### TECHNICAL FIELD

The subject matter described herein relates to techniques for detecting entity behavior in healthcare insurance claims using resolved entity/individual/activity correlation and direct, implicit and inferential relationship detection between actions and entities.

### BACKGROUND

Healthcare fraud continues to be a growing problem in the United States and abroad. There are increasing volumes of fraud with some estimates projecting fraud level activities at over $100B per year for Medicare alone. The United States Federal government estimates that it is identifying and recovering less than 3% of this fraud. It is widely accepted that losses due to fraud and abuse are an enormous drain on both the public and private healthcare systems.

In Medicare, the most common forms of fraud are committed by three distinct types of parties (a) service providers, including doctors, hospitals, ambulance companies, and laboratories; (b) insurance subscribers, including patients and patients' employers; and (c) insurance carriers, who receive regular premiums from their subscribers and pay health care costs on behalf of their subscribers, including governmental health departments and private insurance companies.

(1) Service Providers' Fraud:
a. Billing services that are not actually performed;
b. Unbundling, i.e., billing each stage of a procedure as if it were a separate treatment;
c. upcoding, i.e., billing more costly services than the one actually performed; for example, “DRG creep” is a popular type of upcoding fraud, which classifies patients' illness into the highest possible treatment category in order to claim more reimbursement;
d. Performing medically unnecessary services solely for the purpose of generating insurance payments;
e. Misrepresenting non-covered treatments as medically necessary covered treatments for the purpose of obtaining insurance payments; and
f. Falsifying patients' diagnosis and/or treatment histories to justify tests, surgeries, or other procedures that are not medically necessary.

(2) Insurance Subscribers' Fraud:
a. Falsifying records of employment/eligibility for obtaining a lower premium rate;
b. Filing claims for medical services which are not actually received; and
c. Using other persons' coverage or insurance card to illegally claim the insurance benefits.

(3) Insurance Carriers' Fraud:
a. Falsifying reimbursements;
b. Falsifying benefit/service statements.

Among these three types of fraud, the one committed by service providers accounts for the greatest proportion of the total health care fraud and abuse. In addition, there are instances of fraud when combinations of these three parties conspire to commit fraud by collaborating to falsify and submit claims to receive payouts from the insuring entity.

### SUMMARY

There is a rapidly increasing need to improve fraud investigation tools for insurance claims. This has driven greater demand by government for new anti-fraud techniques as it seeks to address fraud to create a mechanism for healthcare cost reduction.

Due to the complexity of the laws, rules and policies that insurers must abide by, the volume of processes available for claims is increasing as well as increasing volume of potential therapies to investigate as well as the advancing skill of those perpetuating the fraud, a need to create systematic process for detecting fraud in both old and new techniques exists.

The present invention links a plurality of content sets to programmatic analysis that resolve the various content sets to entities and individuals, once the individuals or entities are resolved, the invention applies correlations to the various data sets to detect patterns or to trigger rules that detect current methods of insurance fraud as well as provides the basis to learn and detect new patterns of fraud on an ongoing basis. The invention works both in batch and low latency modes.

The present invention provides a system, method and computer program for processing event records (referred to herein as “activities”) by a means of combining multiple data sources using a plurality of methods to provide a unique and rich context for a number of applications. The system includes data ingest algorithms (including text mining algorithms for ingesting unstructured data), data pre-processing and de-duplication algorithms, data matching and linking algorithms to link entities and activities across databases, a data structure for storing the extracted structured data, a waste, fraud and abuse (WFA) risk scoring model and engine, and system interfaces (APIs) and security models (including Audit Trails) that allow external systems bidirectional access to linked data (targeting information). The system includes a core infrastructure and a configurable, domain-specific implementation. In one embodiment, the present invention is implemented as a WFA detection system. The systems and methods of the present invention involve a fraud detection and prevention model that successfully detects and prevents fraud in real-time. The model can be used to successfully detect and prevent fraud across multiple networks and industries using technologies including social network analysis, neural networks, multi-agents, data mining, case-based reasoning, rule-based reasoning, fuzzy logic, constraint programming, and genetic algorithms. In a second embodiment, as a data analytics system for Comparative Effectiveness Research (CER), the system can support advanced statistical and network measures including analyzing rules, metrics and custom parameters to form output including evaluations and comparative data. In a third embodiment, as an expert locator, the system evaluates characteristics of the expert and outputs a scored target matrix (knowledge network) of expert people, organizations or communities that address one or more topics, problems or solutions.

These enumerated problems and others are addressed in accordance with the teaching of the present invention which provides a system and method for detecting and identifying patterns in insurance claims. Such a system may be implemented in a variety of ways, including one or more computer programs which are storable on a computer readable medium and which include computer logic which is executable on one or more processor driven devices and which enables the user to interact with a central or distributed server arrays to access, process and resolve the data into a refined result.

Other systems, methods, features, and advantages of the present invention will be, or will become, apparent to one having ordinary skill in the art upon examination of the following drawings and detailed description. It is intended that all such additional systems, methods, features, and advantages included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1. Illustrates an example data processing work flow of the present invention

### DETAILED DESCRIPTION

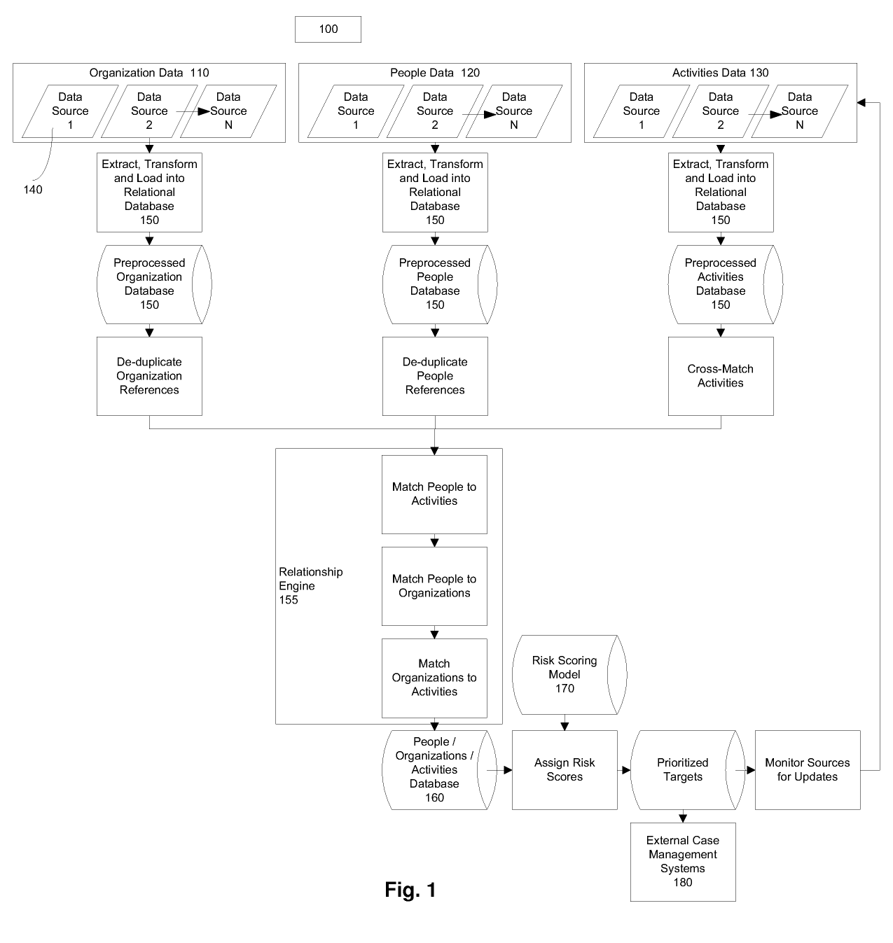

FIG. 1 is a process flow diagram that illustrates a method 100, in which raw data loaded into data warehouses to create data sets of at least Organizational Data 110, People Data 120, and Activities 130. The present invention also may add other data sets that would help resolve relationship networks, such as social networks data and metadata, individual or entity asset registrations, individual or entity financial records or public filings, individual or entity credit card data, or other types of public or private data that is useful and allowed by law for usage in fraud detection. Each of these data sets is aggregated from a variety of Data Sources 140. Once aggregated, the representative data sets are converted into relational database format with relevant fields identified to create linkages between the various data sets and store in a relational database 150. Additionally the data may be preprocessed against training or authority files to resolve the data to individual, organization or activity classes. As part of this detailed description describing entity resolution techniques, a patent application describing an exemplary embodiment of is U.S. patent application Ser. No. 12/341,913 filed Dec. 22, 2008 Systems, Methods, and Software for Entity Relationship Resolution by Jack G. Conrad et al is incorporated by reference hereinto. Once pre-processed, the organizational and individual references are de-duplicated and the activities definitions as loaded are cross matched to maximize pattern detection or rule optimization as they are matched against the individual entities. Once preprocessing is complete, the following three processes occur; the relationship engine 155, matches people to activities, matches people to their representative organizations, and matches organizations to activities. Once this is complete, the resolved people, organizations and activities are collected in a database 160. It is contemplated that this database could be singular, distributed or virtual in nature depending on the local rules and policies of storing data. Once processed initially, the risk scoring model 170 is applied to the combined data and each entity is assigned a risk score based on the type of patterns or behavior that the risk scoring model is detecting. The risk scoring model may make use of social network analysis, neural networks, multi-agents, data mining, case-based reasoning, rule-based reasoning, fuzzy logic, constraint programming, and genetic algorithms in its process It should be noted that there may be more than one risk scoring model 170 applied (individually or in aggregate), (weighted or un-weighted). Once risk scores are applied to the resolved entities and activities, the system then generates a list of prioritized targets and sends them on to a case management system 180 or other systems or individuals responsible for confirming the patterns or behaviors detected by the system 100. The system 100 also once established will process new data, including feedback from users and/or external systems, as it is received to rescore various individuals or organizations as new patterns or behaviors are defined, assigned and scored.

It will be understood that a system in accordance with the teaching of the invention uses functionality residing on traditional computing devices such as I/O peripherals, screens, browser applications etc., but also interfaces these with an array of applications that may reside on mobile devices, distributed processing systems and other network connected devices that have similar functionality.

Any process descriptions or blocks in figures, such as those in the accompanying Figures, should be understood as representing modules, segments, or portions of code which include one or more executable instructions for implementing specific logical functions or steps in the process, and alternate implementations are included within the scope of the embodiments of the present invention in which functions may be executed out of order from that shown or discussed, including substantially concurrently or in reverse order, depending on the functionality involved, as would be understood by those having ordinary skill in the art.

It should be emphasized that the above-described embodiments of the present invention, particularly, any “preferred” embodiments, are possible examples of implementations, merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and the present invention and protected by the following claims.

What is claimed is:

1. A processor enabled method for identifying insurance claim activity comprising:
a. Resolving at least a set of insurance information to at least an entity level;
b. Resolving at least a set of business information to at least an entity level;
c. Correlating the business and insurance information; and.
d. Identifying an insurance claiming pattern of at least one entity.

2. A system, comprising:
a. a plurality of data sources;
b. a relationship processor, configured to identify relationships between data stored in each of the plurality of data sources;
c. a people derivative database, configured to store identified people relationships between data stored in each of the plurality of data sources;
d. a activities derivative database, configured to store identified activities relationships between data stored in each of the plurality of data sources; and
e. a analysis processor, configured to analyze the relationships and output data based on the analyzed relationships to a user.

3. A system, as claimed in claim 1, further comprising:
a. an organization derivative database, configured to store identified organizational relationships between data stored in each of the plurality of data sources.

4. A method, comprising:
a. identifying relationships between data stored in each of a plurality of data sources;
b. storing identified people relationships between data stored in each of the plurality of data sources in a people database;
c. storing identified activities relationships between data stored in each of the plurality of data sources in a activities database;
d. analyzing the relationships; and
e. outputting data based on the analyzed relationships.
(4) A method, as claimed in claim 3, further comprising:
a. storing identified organizational relationships between data stored in each of the plurality of data sources in a organization database.
(5) A computer-readable medium having computer-executable instructions for performing a method, comprising:
a. identifying relationships between data stored in each of a plurality of data sources;
b. storing identified people relationships between data stored in each of the plurality of data sources in a people database;
c. storing identified activities relationships between data stored in each of the plurality of data sources in a activities database;
d. analyzing the relationships; and
e. outputting data based on the analyzed relationships.
(6) A computer-readable medium having computer-executable instructions for performing a method, as claimed in claim 5, comprising:
a. storing identified organizational relationships between data stored in each of the plurality of data sources in a organization database.
(1) A computerized method, comprising:
a. identifying relationships between data stored in each of a plurality of data sources;
b. storing identified people relationships between data stored in each of the plurality of data sources in a people database;
c. storing identified activities relationships between data stored in each of the plurality of data sources in a activities database;
d. analyzing the relationships; and
e. outputting data based on the analyzed relationships.
(7) A computerized method, as claimed in claim 7, further comprising:
a. storing identified organizational relationships between data stored in each of the plurality of data sources in a organization database.
(8) A system substantially as shown or described herein.
